(19) United States
(12) Patent Application Publication
(10) Pub. No.: US 2023/0034213 A1
(43) Pub. Date: Feb. 2, 2023

(54) VESSEL FOR MELTING METAL IN A METAL DROP EJECTING THREE-DIMENSIONAL (3D) OBJECT PRINTER

(71) Applicant: Xerox Corporation, Norwalk, CT (US)

(72) Inventors: Jason M. LeFevre, Penfield, NY (US); Douglas K. Herrmann, Webster, NY (US); Chu-Heng Liu, Penfield, NY (US); Seemit Praharaj, Webster, NY (US); David A. VanKouwenberg, Avon, NY (US); Linn C. Hoover, Webster, NY (US)

(21) Appl. No.: 17/391,265

(22) Filed: Aug. 2, 2021

(51) Int. Cl. B22D 23/00; B33Y 30/00

(52) U.S. Cl. CPC B22D 23/00; B33Y 30/00; B29C 64/112

(57) ABSTRACT

A three-dimensional (3D) metal object manufacturing apparatus is equipped with a vessel having a receptacle that holds melted metal. The vessel has a divider that prevents metal dross formed at a solid metal inlet of the receptacle to migrate to a portion of the receptacle where a melted metal level sensor directs light.

### TECHNICAL FIELD

This disclosure is directed to three-dimensional (3D) object printers that eject melted metal drops to form objects and, more particularly, to the vessel in which the metal is melted in such printers.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more extruders to form successive layers of the plastic material to construct a three-dimensional printed object with a variety of shapes and structures. After each layer of the three-dimensional printed object is formed, the plastic material is UV cured and hardened to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal from one or more ejectors to form 3D objects. These printers have a source of solid metal, such as a roll of wire or pellets, that is fed into a heated receptacle of a vessel in the printer where the solid metal is melted and the melted metal fills the receptacle. As used in this document, the term “receptacle” means a cavity within a structure that is configured to hold melted metal. The receptacle is made of non-conductive material around which an electrical wire is wrapped to form a coil. An electrical current is passed through the coil to produce an electromagnetic field that causes the meniscus of the melted metal at a nozzle of the receptacle to separate from the melted metal within the receptacle and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer is also known as a magnetohydrodynamic (MEM) printer.

The melted metal in the receptacle of the vessel in the printer needs to be maintained at a level sufficient to support metal drop ejection operations without exhausting the supply of melted metal in the printer. In one metal drop ejecting printer a blue laser is directed to the surface level of the melted metal in the receptacle and a reflective sensor monitors the reflection of the laser by the surface level to determine the current height of the melted metal in the receptacle. When the sensor output indicates the level of the surface has dropped to a threshold position within the receptacle, the wire-feeding actuator is operated to feed more solid metal into the receptacle.

During the printing process performed by a MEM printer, the metal, which is typically aluminum and alloys, such as magnesium, form oxides as the metal is melted at the inlet to the vessel. These oxides are commonly referred to as “dross.” As used in this document, the term “dross” means a combination of materials in the vessel of a MHD printer that is unsuitable for object formation. These materials include aluminum oxide, magnesium oxide, aluminum trapped by these oxides, and gas bubbles formed during melting of the solid metal. This dross builds up in the vessel during the printing process and the amount of dross produced corresponds to the amount of metal melted in the vessel. Dross builds at the top of the melted metal in the vessel and causes issues during printing.

One issue arising from the production of dross is the adverse impact of dross on the ability of the laser level-sensor to measure the molten metal level in the vessel. The dross is dark and has a rough surface that affects the reflection of the laser and its reception at the reflective sensor. If the level is not accurately monitored, the vessel can empty during the printing process and ruin the metal object. All dross related level-sensing failures lead to a premature shutdown of the printer, removal of the dross, replacement of the vessel nozzle, and restarting of the printer. Because the printer must be shutdown to remove the dross, its time of operation is limited. This time of operation limitation means the amount of metal ejected is also limited so the number and size of the objects produced is sub-optimal. Additionally, the temperature of the melted metal cannot reach the temperatures optimal for metal drop ejection since the higher melted metal temperatures produce more dross. Finding a way to keep the dross from affecting the melted metal level sensing and extending the time for printer production would be beneficial.

### SUMMARY

A new vessel for a 3D metal object printer keeps dross produced in the vessel from interfering with the sensing of the melted metal level by the laser level sensor. The new vessel includes a wall defining a receptacle within the vessel, the receptacle having a first end and a second end, and a divider within the receptacle to separate a first portion of the receptacle from a second portion, the divider extending a distance from the first end of the receptacle that is less than a distance from the first end to the second end.

A new 3D metal object printer includes the new vessel to keep dross produced in the vessel from interfering with the sensing of the melted metal level by the laser level sensor. The new 3D metal object printer includes an ejector head that defines a receptacle configured to hold molten metal, the receptacle having a first end and a second end, and a divider within the receptacle to separate a first portion of the receptacle from a second portion, the divider extending a distance from the first end of the receptacle that is less than a distance from the first end to the second end.

A new metal insert for filling the new vessel accommodates the divider in the new vessel. The new metal insert includes an elongated portion configured to be received in a first housing of the removable vessel, a slot formed in the elongated portion of the metal insert that is configured to receive a divider within the first housing of the removable vessel, and a bulbous portion configured to be received in a second housing of the removable vessel.

### BRIEF DESCRIPTION OF THE DRAWINGS

The foregoing aspects and other features of a vessel for a 3D metal object printer that keeps dross produced in the vessel from interfering with the sensing of the melted metal level by the laser level sensor are explained in the following description, taken in connection with the accompanying drawings.

FIG. 1 depicts a new 3D metal object printer having a vessel that keeps dross produced in the vessel from interfering with the sensing of the melted metal level by the laser level sensor

FIG. 2A is a top plan view of an upper housing of a vessel having a divider that keeps dross produced in the vessel from interfering with the sensing of the melted metal level by the laser level sensor in the printer in FIG. 1.

FIG. 2B is a side view of an upper housing of the vessel having a divider that keeps dross produced in the vessel from interfering with the sensing of the melted metal level by the laser level sensor.

FIG. 3A is a top plan view of a newly installed vessel having a divider.

FIG. 3B is a top plan view of the vessel of FIG. 3A during a printing process performed with the printer of FIG. 1 that shows the accumulation of dross in the vessel only occurs on the side of the divider where the solid metal is input for melting.

FIG. 4A is an exploded side view of the two-part vessel with a metal insert used to fill the vessel at printer start-up, FIG. 4B shows the installation of the metal insert in the upper housing of the vessel, and FIG. 4C shows the assembled vessel containing the metal insert.

FIG. 5 is a schematic diagram of a 3D metal printer that uses a laser system for determining the position of the surface level of melted metal in the receptacle of the printer that can be affected by dross in the vessel of the printer.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

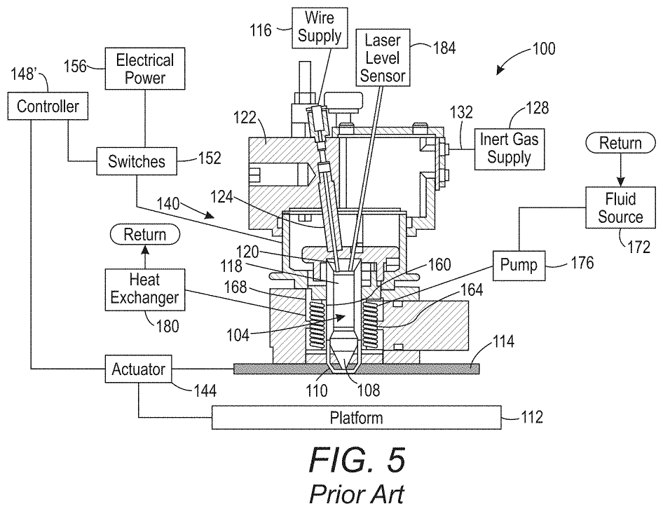

FIG. 5 illustrates an embodiment of a previously known 3D metal object printer 100 that uses a light beam and a reflective sensor to determine the surface level of melted metal within a receptacle of a vessel within the printer. In the printer of FIG. 5, drops of melted bulk metal are ejected from a receptacle of a removable vessel 104 having a single nozzle 108 and drops from the nozzle form swaths for layers of an object on a platform 112. As used in this document, the term “removable vessel” means a hollow container having a receptacle configured to hold a liquid or solid substance and the container as a whole is configured for installation and removal in a 3D metal object printer. As used in this document, the term “bulk metal” means conductive metal available in aggregate form, such as wire of a commonly available gauge or pellets of macro-sized proportions. A source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice in a removable vessel configured for the expulsion of melted metal drops from the receptacle within the removable vessel. As used in this document, the term “ejector head” means the housing and components of a 3D metal object printer that melt, eject, and regulate the ejection of melted metal drops for the production of metal objects. A melted metal level sensor 184 includes a light source and a reflective sensor. In one embodiment, the light source is a laser and, in some embodiments, a blue laser. The reflection of the laser off the melted metal level is detected by the reflective sensor, which generates a signal indicative of the distance to the melted metal level. The controller receives this signal and determines the level of the volume of melted metal in the removable vessel 104 so it can be maintained at the upper level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops.

The ejector head 140 is movably mounted within Z-axis tracks for vertical movement of the ejector head with respect to the platform 112. One or more actuators 144 are operatively connected to the ejector head 140 to move the ejector head along a Z-axis and are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and an uppermost surface of an object on the platform 112.

Moving the platform 112 in the X-Y plane as drops of molten metal are ejected toward the platform 112 forms a swath of melted metal drops on the object being formed. Controller 148 also operates actuators 144 to adjust the vertical distance between the ejector head 140 and the most recently formed layer on the substrate to facilitate formation of other structures on the object. While the molten metal 3D object printer 100 is depicted in FIG. 5 as being operated in a vertical orientation, other alternative orientations can be employed. Also, while the embodiment shown in FIG. 5 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls in which a heater, a coil, and a removable vessel of a 3D metal object printer are located. The removable vessel 104 and the heater 160 are located within this chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148, the controller can access through a server or the like a remote database in which the digital data model is stored, or a computer-readable medium in which the digital data model is stored can be selectively coupled to the controller 148 for access. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, or other polygonal mesh or other intermediate representation, which can in turn be processed to generate machine instructions, such as g-code, for fabrication of the device by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and the uppermost layer of the object on the platform 112.

The controller 148 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148 from either a scanning system or an online or work station connection for processing and generation of the signals that operate the components of the printer 100 to form an object on the platform 112.

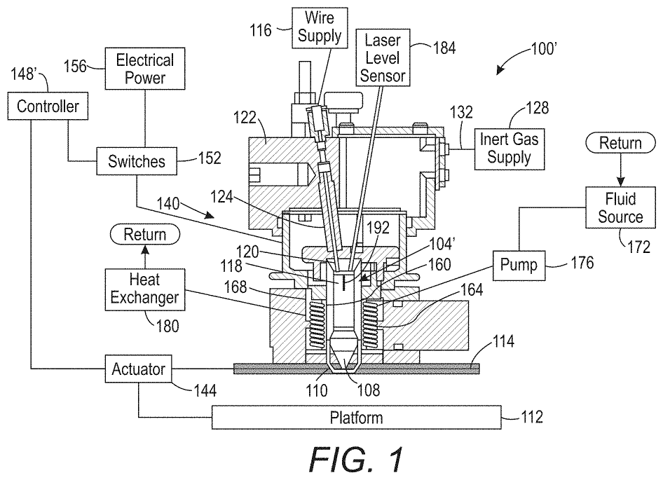

Using like reference numbers for like components, a new 3D metal object printer 100′ is shown in FIG. 1. The 3D metal object printer 100′ includes a novel removable vessel 104′ that includes a divider 192 in the receptacle of the vessel 104′. This divider 192 separates the portion of the vessel receptacle into which solid metal is fed for melting from the portion of the vessel containing the melted metal surface to which the laser level sensor 184 directs its laser. Because the divider 192 does not extend the length of the vessel receptacle the melted metal surface is the same on both sides of the divider. The divider 192 is sufficiently long, however, to prevent the dross produced at the solid metal inlet on the input side of the divider from reaching the melted metal surface on the side of the divider that is measured by the laser level sensor 184. Thus, the accuracy of the measurement of the melted metal surface level is not affected by the production of dross, the printer 100′ stays in operation longer than the printer 100 in FIG. 5, and the throughput of the printer 100′ is greater than the printer 100 in the amount of melted metal ejected. Accordingly, the printer 100′ can produce larger objects and more objects than the printer 100. As used in this document, the term “divider” means any structure that separates an upper portion of a vessel receptacle into two sides so dross is prevented from migrating from one side of the divider to the other side of the divider.

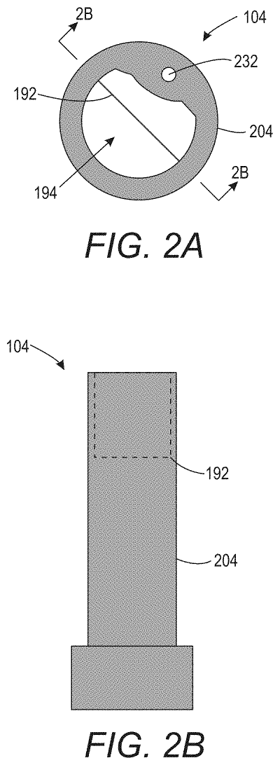

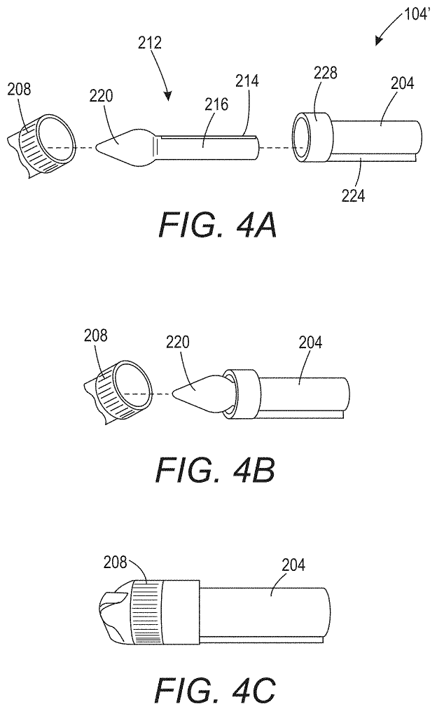

As will be explained below with reference to FIG. 4A, FIG. 4B, and FIG. 4C, one embodiment of the removable vessel 104′ has two separate housings that can be joined together to form the removable vessel for installation in the printer 100′. As shown in the top view of FIG. 2A, the divider 192 extends across the receptable 198 of upper housing 204 from a first side of the inner circumference to the diametrically opposite side of the inner circumference of the upper housing and is positioned so it separates the solid metal input portion 196 of the receptacle 198 from the portion 194 of the receptacle 198 where the laser level sensor 184 directs its laser. As shown in the side view of the FIG. 2B, the divider 192 has a length that is less than a length of the upper housing 204. In one embodiment, the divider 192 has a length that is about 20% of the length of the upper housing 204, although the divider can have a greater or less length provided the length is sufficient to prevent dross migration from the solid metal inlet to the sensing side 194 of the receptacle and is not so long as to prevent melted metal to flow about the lower end of the divider 192.

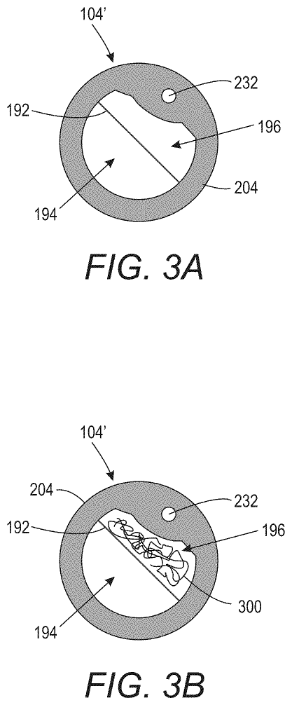

FIG. 3A and FIG. 3B show the effect of the divider 192 on the dross produced at the solid metal inlet. In FIG. 3A, the removable vessel 104′ has been installed and solid metal is being melted in the vessel to fill the receptacle. At this point in the printer's operation, no dross has been produced. As the printer 100′ continues to operate by ejecting melted metal drops and replenishing the melted metal held in the vessel 104′, dross 300 is produced in the solid metal inlet area 196. The divider 192, however, retains the dross 300 at or near the solid metal inlet and keeps it from migrating into the level sensing side 194. Thus, the laser level sensor 184 can continue to sense the melted metal level accurately so an appropriate amount of solid metal is fed into the vessel 104′ and the operational status of the printer 100′ is preserved.

FIG. 4A is a side view of the removable vessel 104′ of the printer 100′. This embodiment of the removable vessel 104′ is of two piece construction that includes an upper housing 204 and a lower housing 208. As used in this document, the term “housing” means a structure having a portion of a receptacle within it and that is configured to be secured to another structure to form a removable vessel. The lower housing 208 includes the nozzle 108 (shown in FIG. 1). Upper housing 204 is longer than lower housing 208 and includes a collar 228 having an external circumference that is equal to the external circumference of lower housing 208. The opening of the lower housing 208 that is opposite the nozzle in the lower housing 208 has a flange that extends from the opening and that has a circumference that is less than the circumference of the interior circumference of the collar 228. Collar 228 has an instep that is recessed from the end of the upper housing 204 that is secured to the lower housing 208 by a distance that corresponds to the distance the flange of the lower housing extends from the lower housing. Thus, the flange of the lower housing slides within the collar 228 until it contacts the instep of the upper housing 204 to fit within the internal circumference of the collar 228. When the upper housing 204 and the lower housing 208 are assembled, they form a receptacle having a shape that corresponds to the metal insert 212. Metal insert 212 is a solid piece of metal, such as aluminum or copper, having an elongated and rounded stem 216 and a bulbous portion 220 that terminates in a pointed end that fits within the nozzle 108. As used in this document, the term “elongated” means structure that is longer than it is wide and the term “rounded” means structure that has at least a partial cylindrical shape. As used in this document, the term “bulbous” means structure having a conical shape along at least a portion of its longitudinal axis. The rounded stem 216 has a slot 214 formed in it to accommodate the divider 192 when the metal insert 212 is installed in the upper housing 204. In one embodiment, the slot 214 in the metal insert 212 is less than one-half the length of the metal insert and, in some embodiments, the length of the slot is less than twenty percent of the length of the metal insert. Upper housing 204 also is formed with a guiding flange 224. This flange fits within a groove in the ejector head 140 to orient the removable vessel 104′ correctly within the printer 100′ and hold the vessel in its correct orientation after the vessel is installed in the ejector head 140.

The upper housing 204 along with the divider 192 are formed with boron nitride and the lower housing 208 is formed with graphite. In some embodiments the divider 192 and the upper housing are integrally formed while in other embodiments, the divider is placed within the receptacle and attached to the wall or walls forming the receptacle. Both of these materials are high temperature ceramics. In one embodiment, the upper and lower housings are heated to temperatures in the range of about 800° C. to about 850° C. for periods of eight hours or longer. The receptacle within the removable vessel 104′ can be coated with suitable anti-oxidant retardant materials that help attenuate the formation of oxides on the metal insert. As used in this document, the term “anti-oxidant retardant” means any material that attenuates the formation of a metal oxide on the type of metal placed in the receptacle of the removable vessel. The boron nitride forming the upper housing is not electrically conductive so it does not interfere with the generation of the electric fields used to eject melted metal drops from the receptacle through the nozzle 108 and the orifice 110. The overall dimensions of the assembled removable vessel are 55 mm with the length of the upper housing being 40 mm and the length of the lower housing being 15 mm. The circumference of the upper housing at the collar 228 is about 50 mm with a diameter of about 16 mm and the circumference at the widest portion of the lower housing is about 50 mm with a diameter of about 16 mm.

Prior to installation in the ejector head 140 of the printer 100, the metal insert 212 is loaded into the removable vessel 104. This is done by either pushing the stem 216 of the insert 212 into the portion of the receptacle in the upper housing 204 (FIG. 2B) or by pushing the pointed end of the bulbous portion 220 into the lower housing. A few spots of cyanoacrylate glue, sometimes more commonly known as “super glue,” are applied to either the instep of the lower housing 208 or the inner circumference of collar 228 and then the instep of the lower housing 208 is slid within the inner circumference of collar 228 to secure the lower housing and upper housing together as shown in FIG. 2C. This glue is removed by the heat applied from the heater 160 during operation of the printer so the two housings can be separated for printer maintenance. Inert gas source 128 is coupled to the upper housing to supply insert gas to the receptacle within the removable vessel to attenuate oxidation of the melted metal within the removable vessel. A thermocouple (not shown) is placed in the opening 232 (FIG. 2A) to provide a signal indicative of the heat in the removable vessel so the controller can regulate the operation of the heater 160.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

1. A metal drop ejecting apparatus comprising:
an ejector head that defines a receptacle configured to hold molten metal, the receptacle having a first end and a second end; and
a divider within the receptacle to separate a first portion of the receptacle from a second portion, the divider extending a distance from the first end of the receptacle that is less than a distance from the first end to the second end.

2. The metal drop ejecting apparatus of claim 1 wherein the receptacle is within a vessel configured for installation in and removal from the ejector head.

3. The metal drop ejecting apparatus of claim 2 further comprising:
a solid metal guide configured to move solid metal into the first portion of the receptacle;
a level sensor having a light generator and a reflective sensor, the light generator being configured to direct light into the second portion of the receptacle; and
the divider being positioned between where the first portion of the receptacle receives the solid metal and where the second portion of the receptacle receives the light from the light generator.

4. The metal drop ejecting apparatus of claim 3 wherein the distance that the divider extends from the first end of the receptacle is less than half of the distance between the first end and the second end of the receptacle.

5. The metal drop ejecting apparatus of claim 4 wherein the distance that the divider extends from the first end of the receptacle is about twenty percent of the distance between the first end and the second end of the receptacle.

6. The metal drop ejecting apparatus of claim 5 wherein the divider extends from a first position between the first portion of the receptacle and the second portion of the receptacle to a second position diametrically opposite the first position.

7. The metal drop ejecting apparatus of claim 6 wherein the divider is essentially comprised of boron nitride.

8. The metal drop ejecting apparatus of claim 7 wherein the divider is integrally formed with the vessel.

9. The metal drop ejecting apparatus of claim 8 wherein the light generator is a laser.

10. A vessel for holding melted metal within an ejector head of a metal drop ejecting apparatus comprising:
a wall defining a receptacle within the vessel, the receptacle having a first end and a second end; and
a divider within the receptacle to separate a first portion of the receptacle from a second portion, the divider extending a distance from the first end of the receptacle that is less than a distance from the first end to the second end.

11. The vessel of claim 10 wherein the divider extends from the first end by a distance that is less than half of the distance between the first end and the second end of the receptacle.

12. The vessel of claim 11 wherein the distance that the divider extends from the first end is about twenty percent of the distance between the first end and the second end of the receptable.

13. The vessel of claim 12 wherein the divider extends from a first position between the first portion of the receptacle and the second portion of the receptacle to a second position diametrically opposite the first position.

14. The vessel of claim 13 wherein the divider is integrally formed with the vessel.

15. The vessel of claim 14 wherein the divider is essentially comprised of boron nitride.

16. A metal insert for preloading a removable vessel for installation in an ejector head of a metal drop ejecting apparatus comprising:
an elongated portion configured to be received in a first housing of the removable vessel;
a slot formed in the elongated portion of the metal insert that is configured to receive a divider within the first housing of the removable vessel; and
a bulbous portion configured to be received in a second housing of the removable vessel.

17. The metal insert of claim 16 wherein the slot has a length that is less than a length of the metal insert.

18. The metal insert of claim 17 wherein the length of the slot is about twenty percent of the length of the metal insert.

19. The metal insert of claim 18 wherein the metal insert is comprised essentially of aluminum.

20. The metal insert of claim 18 wherein the metal insert is comprised essentially of copper.
